(19) United States
(12) Patent Application Publication
(10) Pub. No.: US 2016/0286434 A1
(43) Pub. Date: Sep. 29, 2016

(54) Method and Device for Controlling Processing Load of a Network Node

(71) Applicant: TELEFONAKTIEBOLAGET L M ERICSSON (PUBL), Stockholm (SE)

(72) Inventor: Rogier August Caspar Joseph Noldus, Goirle (NL)

(21) Appl. No.: 15/033,965

(22) PCT Filed: Nov. 6, 2013
(86) PCT No.: PCT/EP2013/073141

§ 371 Date: May 3, 2016

(51) Int. Cl. H04W 28/10

(52) U.S. Cl. CPC H04W 28/10; H04W 88/08

(57) ABSTRACT

Controlling the processing load in a first node 100, resulting from received signaling by particular second nodes 210, 220. 230, 240, by determining the amount of signaling received from the particular second nodes. If the average signalling received over a predetermined period in the first node 100, results in a processing load higher than a predetermined threshold level 520, a calculation is performed by the first node based on the actual processing usage and the threshold level 520, yielding a signalling amount limitation for a second node. Subsequently a table comprising the calculated allowed processing load, representing an amount of signalling allowed, is arranged and submitted to the respective second node. This signalling amount limitation table enables the second node to limit its amount of signaling towards first node 100, with the intention to prevent congestion in first node 100. In case the first node 100 acts as an agent for third nodes 310, 320, 330, 340, the processing load resulting from signaling in the third nodes is determined by the first node 100 either by accumulation of the signalling received in the first node 100, sent by the second nodes ad dressed for these third nodes, or by requesting these third nodes.

### TECHNICAL FIELD

The present invention relates generally to enable a network node to control its processing load, resulting from signaling received, reducing the probability of node congestion.

### BACKGROUND

Network nodes have processing capacity that is available to process received signaling. The signaling might comprise signaling to be processed locally, e.g. for looking up data in a local database, or calculations performed by a local processing unit. The signaling might also comprise processing tasks that are to be addressed or processed by another network node. In the latter case the node receiving the signaling performs as an agent, being either a relay agent, reading the header information and routing the signaling to the destination address, or a proxy agent that may apply a policy like rejecting or forwarding the signaling after modifying the contents, or a redirect agent returning signaling requests to the original client where the servicing can be performed, or a translation agent, translating a signaling into another protocol.

In either case, wherein the processing of a request is executed in the node receiving the signaling or in another node, the processing of the signaling header consumes an amount of processing available in the node receiving the signaling.

When the node receiving the signaling becomes congested due to an amount of signaling received, larger then the node is able to process, the nodes submitting the signaling request, and waiting for a reply, might even worsen the congested situation by re-submitting the same signaling in case of delayed or no reply.

Known strategies for preventing node congestion are to drop received signaling. This strategy takes into account that higher networking layers note the lost packets by time-outs and attempt to complete the signaling by delayed re-transmission of the same signaling.

Publication US20130215750A1, titled “Apparatus & Method”, presents a method of controlling data packet congestion in a data packet network, and comprises determining a reference flow condition that results in data packet congestion at a node of a data packet network, and identifying a data packet flow having a flow condition substantially equal to the reference flow condition.

For such an identified data packet flow the following actions are taken causing a data packet to be dropped from the identified data packet flow, allowing a predetermined number of data packets from the identified data packet flow to proceed, and dropping data packets from the identified data packet flow subsequent to the predetermined number of data packets, until the packets that were not dropped have been delivered to the egress ports of the network

Another strategy to prevent node congestion is the application of “load-balancing”, presented by publication U.S. Pat. No. 8,542,590B2, titled “Bi-directional load balancing, applicable in cases where more than one network node is able to handle signaling”. This document shows a method that may include receiving, from a user device, a request to access a Long Term Evolution (LTE) network; sending, to one or more servers of a group of servers, a query to obtain information associated with a respective traffic condition and processing capacity; identifying a particular server via which to establish a communication session with the user device based on a determination that the particular server has a reserve processing capacity that is greater than a respective reserve processing capacity associated with other ones of the servers, where the reserve processing capacity is based on a traffic condition and processing capacity associated with the particular server; and sending, to the particular server, an instruction to establish the communication session, where sending the instruction enables the particular server to establish the communication session via which the user device is to access the network,

As processing capacity in a node is limited by a combination of a.o.: number of processors, processor speed, memory availability and also subsystem performance like memory access timing, internal bus speed and interface speed, it is a problem how to efficiently apply the available processing capacity in a network node receiving an amount of signaling to be processed in such a way that a node does not become congested by the signaling received.

### SUMMARY

It is an object of the present invention to provide a method and apparatus, to prevent node congestion in a first node or third node, wherein the congestion results from signaling received from at least one second node.

In an aspect of the invention a method for controlling at least one second node is proposed. The method for controlling processing load in a first network node, wherein the processing load results from signaling received by the first node and the first node is communicatively connected to at least a second network node is performed by a number of steps described below.

A first determining step, by the first node is performed, wherein the processing load in the first node resulting from the signaling received from the at least one of a second node is determined.

A second defining step, by the first node is performed, wherein a signaling amount limitation for the at least one second node is derived from the determined processing load.

A third submitting step, by the first network node is performed, wherein the defined signaling amount limitation to the at least one second node is submitted, such that the at least one second node is enabled to limit its amount of signaling towards the first node, according to the defined signaling amount limitation.

In still another aspect of the invention, the determining step, determines for the at least one second node an amount of signaling received during a predetermined period. The determining step also includes accumulating of an amount of processing load in the first node resulting from the signaling received from the at least one second node over the predetermined period.

In still another aspect of the invention, the defining step comprises an allocation step, wherein, when the determined accumulated processing load is higher than a predetermined threshold level, the signaling amount limitation, that is at least a part of the accumulated processing load below the threshold level, is allocated to the at least one second node.

In still another aspect of the invention the submitting step of the method further comprises, the submitting of the defined signaling amount limitation as a table to the at least one second node, when the defined signaling amount limitation differs at least a predetermined value with the last submitted signaling amount limitation.

In still another aspect of the invention, there is presented a method for controlling a processing load in a third network node by a first network node. In this method the processing load results from an amount of signaling addressed to the third node and routed via the first node, the first node acting as an agent. The first node is communicatively connected to at least a second network node and the third node, the signaling is received from the at least one second node and the method comprises a number of steps stated below.

A first determining step is performed by the first node, determining the processing load in the third node resulting from the signaling received from the at least one second node via the first node.

A second defining step is performed by the first node, defining a signaling amount limitation for the at least one second node, derived from the determined processing load.

A third submitting step is performed by the first node, wherein the defined signaling amount limitation is submitted to the at least one second node, such that the at least one second node is enabled to limit its amount of signaling addressed to the third node, according to the defined signaling amount limitation.

In still another aspect of the invention, the determining step further comprises the determining for the at least one second node an amount of signaling received by the third node during a predetermined period. The determining step also includes accumulating of an amount of processing load in the third node, that results from the signaling received from the at least one second node over the predetermined period.

In still another aspect of the invention the defining step further comprises an allocation step when the determined accumulated processing load in the third node is higher than a predetermined threshold level. The signaling amount limitation, is at least a part of the accumulated processing load below the threshold level, and is allocated to the at least one second node.

In still another aspect of the method the submitting step further comprises the submitting of the defined signaling amount limitation as a table to the at least one second node when the defined signaling amount limitation differs at least a predetermined value with the last submitted signaling amount limitation.

In still another aspect of the invention, the first node acting as an agent for a third node is also enabled to have its own processing load controlled by having the determining step performed for both the third node and the first node, and perform the defining and submitting steps as presented above.

In still another aspect of the invention of controlling the processing load in a first or third network node, wherein the processing load results from the signaling load of a second node, a method is presented to enable the second node to control its signaling submission with steps illustrated below.

A first receiving step, performed by the second node, receives a signaling amount limitation table.

A second Interpreting step, performed by second node, interpreting a signaling amount limitation value of the table into a number and type of messages to be send within a predetermined period

A third limiting step, performed by the second node, limiting its amount of signaling sent towards the first or third node according to the interpreted signaling amount limitation.

In still another aspect of the invention a first network node is presented. The node arranged to control processing load in the first node, wherein the first node comprises: a processor arranged to process program instructions; a memory arranged to store the program instructions and an interface for connecting to at least a second node.

This first node additionally comprises; a determiner unit arranged to determine the processing load resulting from signaling received from the at least one second node and a definer unit, arranged to define a signaling amount limitation for the at least one respective second node.

The interface is arranged to submit the signaling amount limitation to the at least one second node, and the processor arranged to control the determiner unit, the definer unit and the interface

In still another aspect of the invention a second network node is presented, that is arranged to enable controlling a processing load in another network node.

The node comprises; a processor arranged to process program instructions; a memory arranged to store the program instructions, and an interface for connecting to a first node. The interface is arranged for submitting signaling and receiving a signaling amount limitation table.

The second node further comprises: a signaling interpreter unit for interpreting the signaling amount limitation value of the received table into a number and type of messages to be send within a predetermined period, and a signaling limiter unit for limiting the amount of signaling sent towards the first or third node according to the interpreted signaling amount limitation.

In still another aspect of the invention, a first network node is presented that has a congestion prevention module. This module comprises; a determination module for determining the accumulated processing load in the first or a third node, the load resulting from signaling received from at least one second node; a comparing module for comparing the accumulated processing load against a predetermined threshold, and a timer check module for checking whether a timer has timed-out.

The congestion prevention module further comprises; a definer module for defining a signaling amount limitation, based on the determined accumulated processing load and the predetermined threshold, and a submit module for submitting the signaling amount limitation as a table to the at least one second node as to enable the second node to limit its signaling according to the table.

In still another aspect of the invention, a computer program is presented, which, when being executed by a processor in a first network node, is adapted to carry out or control a method for preventing congestion in a first or third node comprising a number of steps.

In a first determining step, a processing load resulting from signaling received by the first node is determined.

In a second defining step, a signaling amount limitation for a second node derived from the determined processing load is detected.

In a third submitting step, the defined signaling amount limitation is submitted to the second node, such that the second node is enabled to limit its amount of signaling towards the first node, according to the defined signaling amount limitation.

In still another aspect of the invention, a computer program is presented, which, when being executed by a processor in a second node, is adapted to carry out or control a method for preventing congestion in a first or third node comprising a number of steps.

In a first receiving step, by the second node, a signaling amount limitation table is received.

In a second interpreting step, a signaling amount limitation value of the received table is interpreted into a number and type of messages to be send within a predetermined period.

In a third limiting step, by the second node, its amount of signaling towards a first node is limited according to the received defined signaling amount limitation.

These and other embodiments according to the present invention are now illustrated in more detail with reference to the enclosed drawings.

### BRIEF DESCRIPTION OF THE DRAWINGS

FIG. 1 is a block diagram illustrating an embodiment of a network;

FIG. 2 is a flowchart illustrating an embodiment of method steps;

FIG. 3 is a signaling diagram illustrating an embodiment of method steps;

FIG. 4 is a diagram illustrating a table of an embodiment of method steps;

FIGS. 5a, 5b and 5c are diagrams illustrating graphs of embodiments of method steps;

FIG. 6 is a block diagram illustrating an embodiment of a network;

FIG. 7 is a signaling diagram illustrating an embodiment of method steps;

FIG. 8 is a diagram illustrating a table of an embodiment of method steps;

FIG. 9 is a block diagram illustrating an embodiment of a network;

FIG. 10 is a block diagram illustrating an embodiment of a network node;

FIG. 11 is a block diagram illustrating an embodiment of a network node, and

FIG. 12 is a block diagram illustrating an embodiment of a network node.

### DETAILED DESCRIPTION

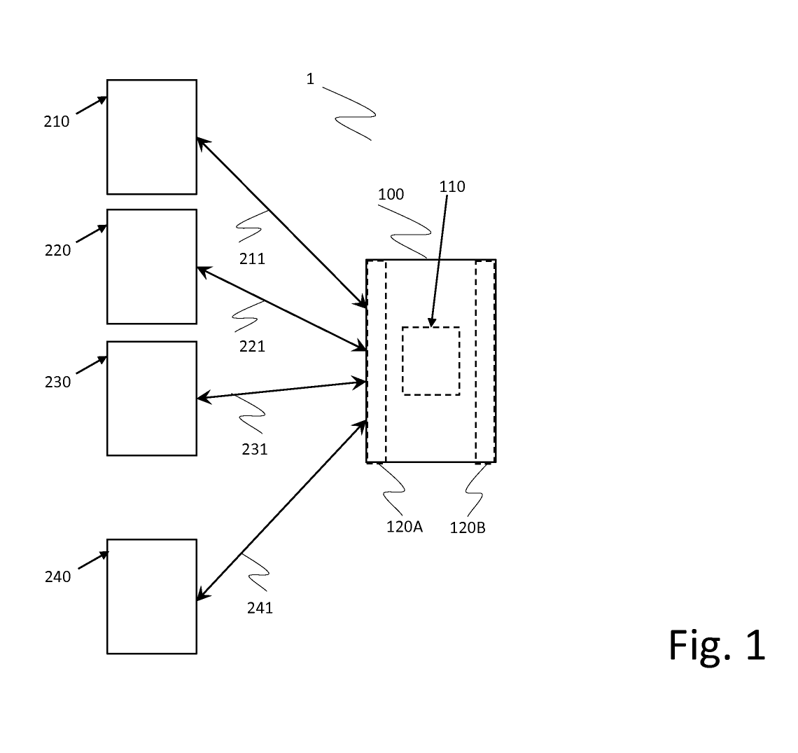

FIG. 1 is a block diagram illustrating an embodiment of a network. Network 1 comprises, as an example, a number of network nodes 100, 210, 220, 230 and 240. First network node 100 is for the explanation of this invention a network node that should be prevented from getting congested by signaling originated from at least one second node 210, 220, 230, 240, comprised by a plurality of second network nodes 210, 220, 230 and 240. The number of second network nodes 210, 220, 230 and 240, depicted in FIG. 1, is an arbitrary number, being at least one. FIG. 1 is kept simple for explanation purposes with a small number of nodes, conveniently arranged such that the survey is clear. It should however be kept in mind that this invention is suitable to large networks with a large number of nodes, geographically positioned in different locations.

In this description the term “signalling” is to be understood as a message, request or reply, transferred or communicated between nodes.

In this description the term “node” is to be understood as a server, client or host, being a computer, an entity in a cloud network or software defined network.

Each node of the plurality of second network nodes 210, 220, 230 and 240 is arranged to send and receive a signaling to and from first network node 100 via bi-directional interface links 211, 221, 231 and 241 respectively, such that the second network nodes are communicatively connected to the network interface 120A of first network node 100.

First network node 100 is arranged to receive several type of signaling from the connected second network nodes addressed for this first node. This signaling comprises e.g.:
messages, being a request to control a feature of node 100;
messages being a request to retrieve data from node 100;
messages with content to be processed by node 100;
messages with content to be stored by node 100;

All signaling, such as the message types listed above, received via interface 120A of first node 100, have to be processed by the processor 110 of node 100, as to decide which action has to be performed. Each processing action by processor 110 requires the processor 110 to read at least a header of the message and perform or execute the appropriate instructions either previously stored or contained in the message.

Processing requires processing performance or capability, where the processing performance depends on a combination of a.o. number of logical or physical processors, efficient code, memory size, memory access time, bus-speed, clock frequency. The current processing performance load or utilization of a processor may reach up to 100% of the maximum performance. An example for retrieving a current processing load of a processor by means of a request is a Linux “vmstat” command.

When the amount of received signaling, received in node 100, could not be entirely processed as the available processing performance does not suffice, node 100 becomes a congested node, meaning that at least some requests or messages cannot be read and processed.

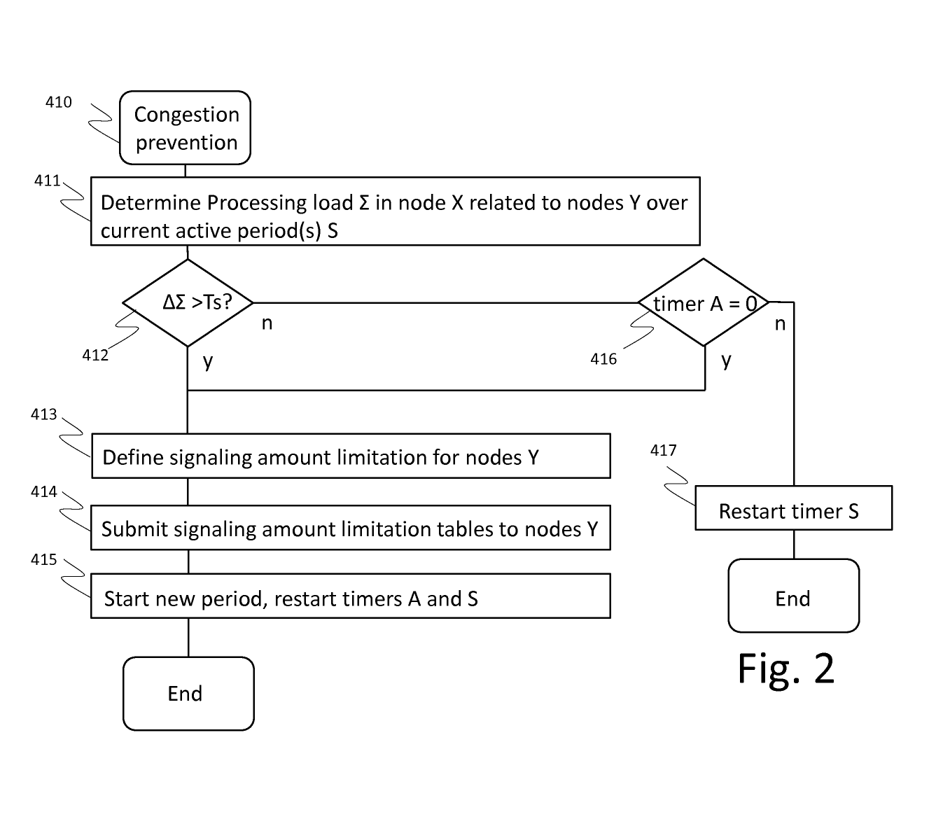

FIG. 2 is a flowchart illustrating an embodiment of method steps. FIG. 2 presents a method to prevent node 100 to become congested.

A scheduler within node 100, regularly initialyzes a process identified as “Congestion prevention” 410, which starts with a determination 411 of the load of processing in node “X”, being in this example first node 100, caused by processing of signaling received from second nodes “Y”, being at least one of second nodes 210, 220, 230, 240 in this example, over a current period or time-frame S, timed by timer S.

Timer S is related to scheduling of the execution of module 410 and is suggested to have a period from 0.5-5 seconds. Module 410 is arranged to have both incidental congestion detection, and as well a regular process for congestion detection and recovery. Timer S enables a rapid reaction to prevent congestion of first node 100 by sudden signaling load increase, and timer A enables a slower process for regular congestion prevention. Timer A times a period of A seconds, being a number of times of the period of timer S, and supports a regular communication with the second nodes 410, 420, 430 and 440.

As an example for the explanation, it is assumed that the maximum processing load or utilization of the first node 100 is expressed as 100.000 units, representing the execution of an amount of received signaling. For the examples below signaling load is expressed in units with reference to this maximum processing load figure. Any processing load due to other activities, like submitting signaling or internal processing unrelated to the received signaling are to be regarded as not being part of the term “processing load” or “maximum processing load” as used in this explanation.

In a next step, it is checked 412 whether the current detected processing load, accumulated during a period t{(t, n)|t=n*S, n*S<A, nεZ}, is beyond a first threshold level “Ts”, defined as an incidental threshold level. When the current detected processing load is higher than the first threshold level Ts, the next step is to define 413 a signaling amount limitation for at least one of the second nodes 210, 220, 230 and 240, as to prevent a possible congestion.

The signaling amount limitation is meant to be a guideline for the second node as to limit the amount of signaling addressed to node 100, thereby preventing first node 100 becoming congested, and is expressed in a figure e.g. as 30.000 units for node 210, and 20.000 units for node 220.

As a next step these values are comprised in signaling amount limitation tables, and submitted 414 by the first node 100 to the second nodes 410, 420, 430 and 440 respectively.

Finally, the timers A and S are restarted 415, as to enable a return to a regular scheme, where the signaling amount limitation messages are sent to the second nodes at regular intervals.

Taking into account that second nodes 410, 420, 430, and 440 need a mechanism to define the desired messages per second, addressed to first node 100 according to the received respective signaling amount limitation messages, it is regarded convenient for the second nodes to receive a limitation that is normalised to a fixed period.

Timer A is proposed in FIG. 2 as a decrementing timer, each time set with a value “A” and decrementing until zero. The value for “A” corresponds to a period of seconds, e.g. between 5 s until 60 s. A value of 30 s will be used as example in the remainder of this description, but should however not be regarded as distinctive value, as this value should be defined on a case by case basis depending on network type, size, requirements, etc.

When implementing this method the scheduling of module 410 by timer S should be a number of times higher than the frequency caused by time-out of timer A, as to detect a sudden increase in processing load and react adequately towards the second nodes.

If e.g. the first node 100 determines at 412 that the current accumulated load is above first threshold level Ts within a period of 6 s, with a defined 413 signaling amount limitation of 5000 units for node 210 for a period of 6 s, a signaling amount limitation table is sent by node 100 to the second node 210, with a signaling amount limitation normalized to the period of 30 s. In this example the signaling amount limitation for second node 210 will be (30/6)*4000=20.000 units.

In cases where check 412 revealed that the current load did not pass the threshold level “Ts”, timer A is checked 416 whether the current period has passed. When period A has passed (timer A=0), the flow 413-415, as described above is performed. If the check 416 yields that the period A has not yet passed, timer S is restarted, and the module waits during a period S to be scheduled again.

As well as in first node 100, the second nodes 210, 220, 230, 240, applying the method presented, have a local timer that is arranged to provide a period with the same value A, as in first node 100.

A processor or computer or cloud computing entity [performs all steps provided by the method presented.

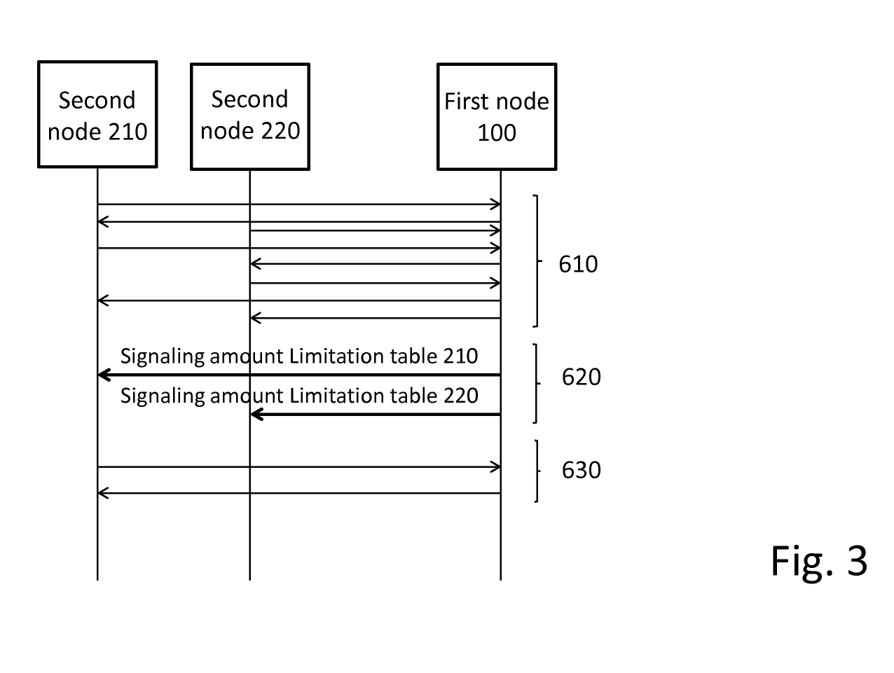

FIG. 3 is a signaling diagram illustrating an embodiment of method steps;

FIG. 3 presents first node 100 and as an example two second nodes 210 an 220, exchanging common signaling 610, being requests, replies, messages, etc.

At some moment in time 620, either when a sudden increase in processing load is detected 412, or when a regular period A has ended 416, first node 100, submits 414, after defining 413 the signaling amount limitation for each involved second node 210, 220, said signaling amount limitation tables to the respective second nodes 210, 220.

Next the second nodes continue normal signaling 630, albeit taking the last received signaling amount limitation taken into account when submitting signaling to first node 100.

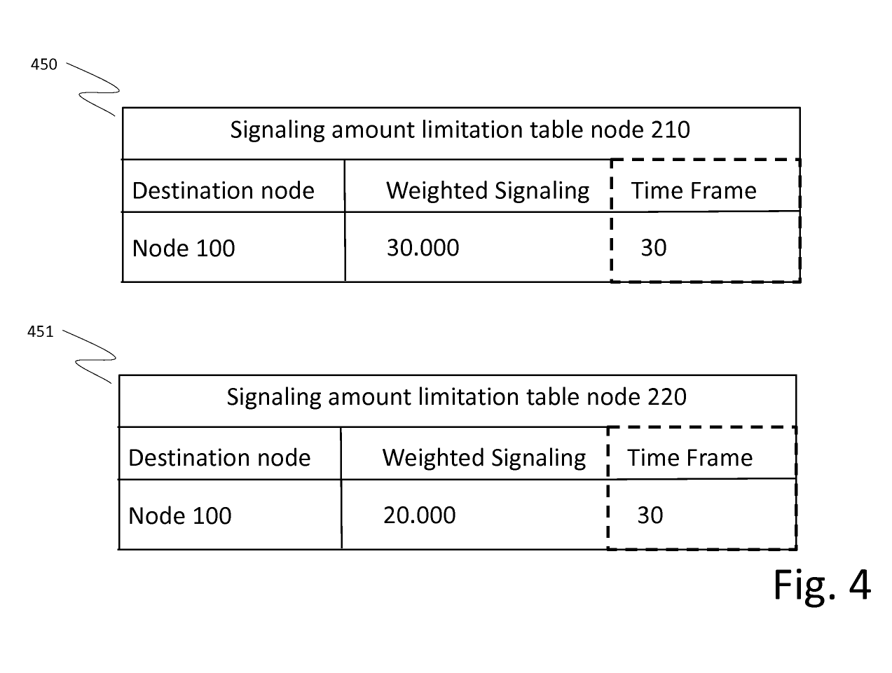

FIG. 4 is a diagram illustrating a table of an embodiment of method steps.

In step 414 the signaling amount limitation tables are submitted to the respective second nodes 410, 420, 430 and 440. As an example FIG. 4 shows the signaling limitation tables 450, 451 as compiled by the first node 100 towards second nodes 210 and 220 respectively as an example with the figures mentioned before. The signaling amount limitation tables 450, 451, comprising the signaling amount limitation under the header “Weighted signaling” are stored in a storage unit of second nodes 210 and 220 respectively. The term “Weighted signalling” means that the expressing in units corresponds to an amount of signalling, resulting in a number of units of processing load in first node 100.

As more signaling receiving nodes than first node 100 may deploy the method presented here, an identifier identifying first node 100 under the header “Destination node”, is comprised by the signaling amount limitation table, such to indicate that only signaling aimed for first node 100 should be submitted according to the current limitation scheme of 30.000 and 20.000 units respectively.

The default signaling amount limitation is calculated and normalized by first node 100 with respect to a default period of 30 s.

It is an option to send non-normalized units along with the corresponding period in the signaling amount limitation table, such that the second nodes 410, 420, 430, 440 do not have to be provided separately with the default period. The second nodes, deploying the latest received units indicated in the signaling amount limitation table, are expected to average their signaling load over the current period, as indicated in the “Time-frame” field, or if not provided in the table 450, 451, a default period, provided in another way.

Alternatively the signaling amount limitation is calculated and normalized with a variable period, regarded as being beneficial when the processing load in first node 100 substantially fluctuates, such that the default period of 30 s. is regarded too long when a more pro-active reaction of first node 100 is expected as to prevent congestion due to highly fluctuating signaling reception. In this case the current period, applied by first node 100 is comprised in the signaling amount limitation table, and the normalization of the value under the header “Weighted value”, is based on the value shown under the header “Time-frame”, indicating the period in e.g. seconds.

The units correspond to the load impact by the signaling received caused in the first node 100. Each signaling message or request has a corresponding value in a predetermined conversion table, such that when sending the signaling message, the second node checks:
the corresponding number of units for signaling message/request for node 100;
the amount of units still available for the current period, and
whether the intended signaling message/request still fits in the allowable current limit.

When the check is positive the signaling is submitted to first node 100. In the other case the signaling is queued, and submitted until a new period is started in the second node, or a new signaling amount limitation table is received from first node 100.

The second node decides itself to submit high prioritized signaling messages to be sent above the current signaling amount limitation for reasons of process continuation.

As an alternative to the conversion table from messages/requests to units, the second node performs an algorithm representing a load impact, as perceived by first node 100, on each signaling message to be sent, and apply the achieved number of units per signaling message.request in its further processing towards first node 100.

As another alternative, an operator of the network 1 may shutdown the interface of first node 100 for all second nodes apart for a distinctive one. This distinctive second node generates a determined number of a specific type of a signaling message/requests in a determined period towards first node 100 and either the operator notes the processing load in units, or the second node requests for the processing load in units, thereby providing a signaling amount limitation to the second node. The perceived load is determined per type of signalling and stored in a table applicable for later use. Another option is to submit a realistic mix of signalling messages/requests.

As the second node has submitted the signaling messages/request, the second node is enabled to correlate to some extent the returned units with the signaling amount limitation received. When in normal operation, the correlation is to be used for interpretation of the received signaling amount limitation vs. the signaling messages/request to be submitted.

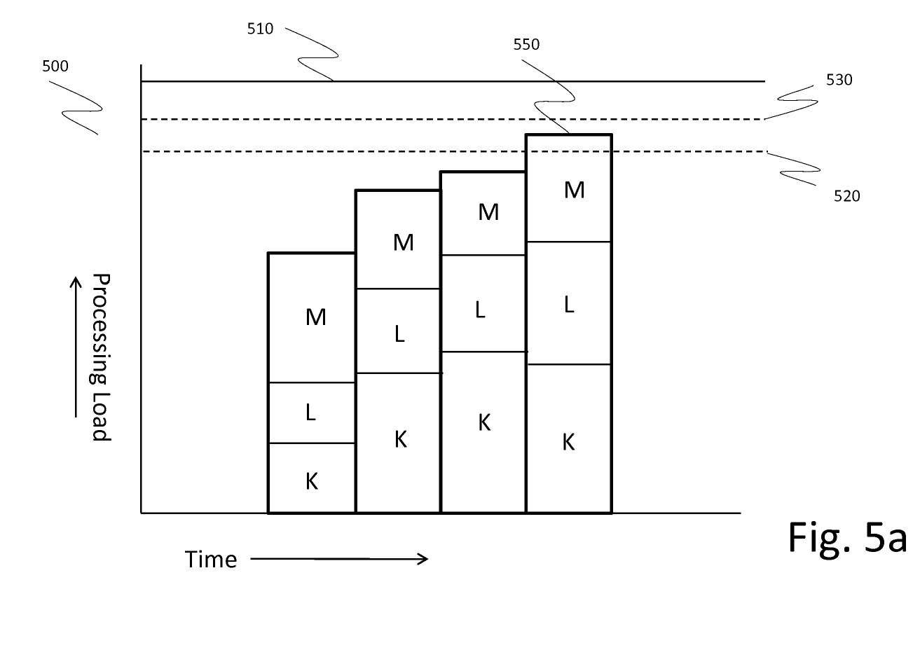

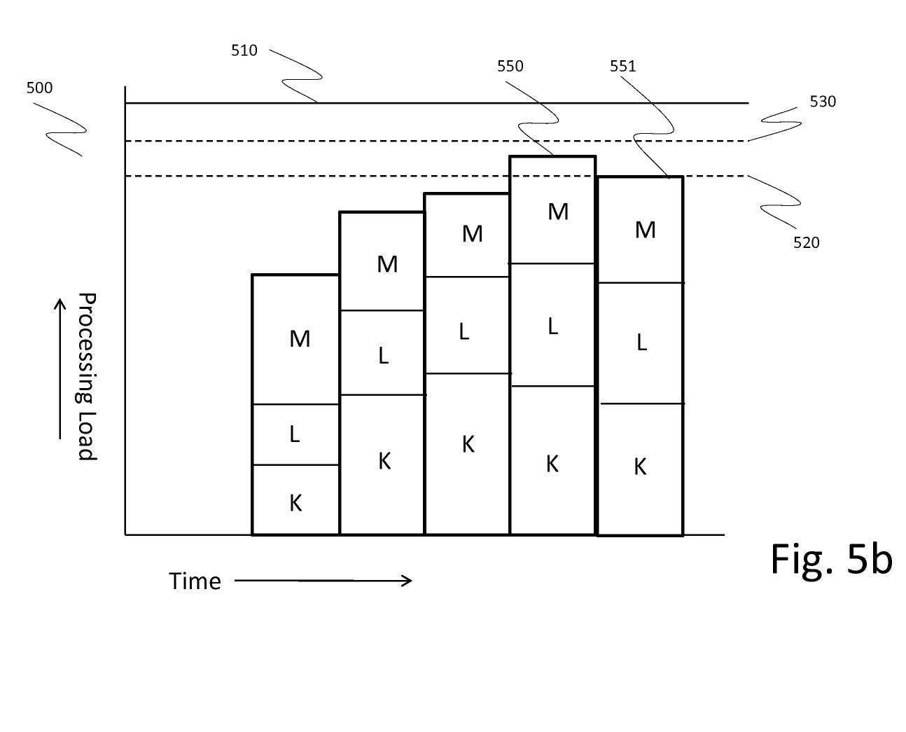

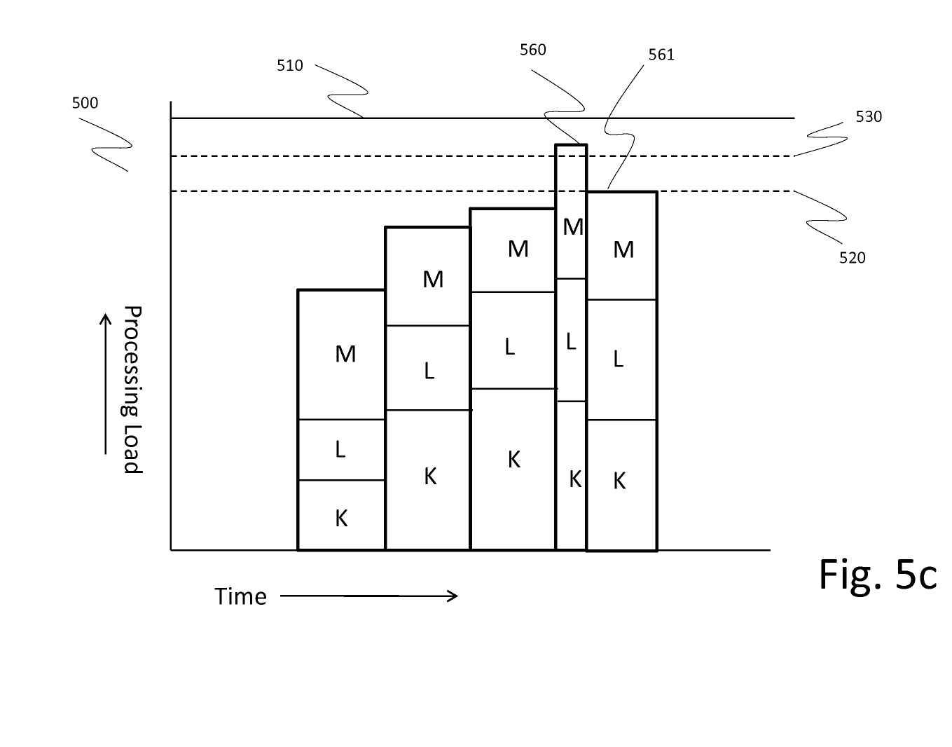

FIG. 5a is a diagram illustrating a graph of an embodiment of method steps. FIG. 5a represents a time versus load graph 500 of the processing load in first node 100. Presented are horizontal lines 510 representing the maximum processing load of node 100, representing the 100.000 units, and two dashed horizontal lines 520, 530 representing threshold processing load lines.

The two threshold lines 520, 530, can have a distinctive or same value, as long both lines have a value lower than the maximum processing load line 510.

As an example the second threshold line 520 indicates a threshold level for the longer term congestion detection process, defined by timer A and applied in calculations in step 413. The first threshold line 530 indicates a threshold level for the shorter term congestion detection process, defined by timer S and applied in step 412.

Additionally presented are as an example four columns with the width of the period defined by timer A, each representing the accumulated processing load resulting from three different second nodes indicated as nodes “K”, “L” and “M”. It is shown that the accumulated signaling load represented by the fourth column 550 passes the second threshold line 520.

The Columns are to be regarded an average of the total processing load over period A in first node 100.

The second threshold line 520 is a value being lower than the maximum processing load in first node 100, in practice deliberately chosen such that during a period A, it is normally not to be expected that the accumulated processing load caused by received signaling from the connected second nodes 410, 420, 430, 440, reaches the maximum processing load level 510, within a period A, thereby preventing congestion in the first node 100 in a normal situation.

The fourth column 550 indicates that the accumulated processing load in first node 100, as a result of received signaling by second nodes 210, 220, 230, 240, averaged over period A is higher than previously defined second threshold line 520.

The exceeding of the processing load of second threshold line 520 is detected in step 413 and requires a new signaling amount limitation table to be signaled to the respective second nodes.

FIG. 5b is a diagram illustrating a graph of an embodiment of method steps. FIG. 5b represents a time versus load graph 500 of the processing load in first node 100. Following FIG. 5a the detection of exceeding column 550 above the second threshold line 520 requires one of the alternative scenarios to request the second nodes to limit their signaling in favour of first node 100, to prevent becoming congested.
As an alternative, the total signaling load detected 550 in the last period, is broken down into a percentage used for each second node K, L, M. Suggesting the accumulated signaling load detected amounted 90.000 units in a 30 s period. As in the example signaling was received from these nodes in roughly a 40/30/30 division, this division is applied to the current processing second threshold line 520 of 80.000 units, so second node K should limit its signaling to a value corresponding to 40% of 80.000=32.000 units and the other second nodes L and M should limit the signaling amount to a value corresponding to 30% of 80.000=24.000. The values 32.000, 24.000 and 24.000 units are subsequently sent to nodes K, L and M respectively as a signaling amount limitation, optionally accompanied with a period value of 30 s. This alternative is depicted in FIG. 5b, with the expectation that nodes K, L and M each had sufficient signaling to be sent, resulting into new column 551, having an accumulated processing load substantially equal to the value represented by second threshold line 520.
A further alternative is to have only a small number of second nodes, having the highest signaling, evaluated for the congestion reduction process. Suggest that second nodes P and Q occupy 80% of the processing load of 90.000 units, and a number of other second nodes the remaining 20%. The other second nodes are allowed to continue to consume the 20% of 90.000 units=18.000 units. Applying the second threshold line 520 of 80.000 units, the second nodes P and Q together are allowed to consume the 80.000-18.000=62.000 units. In case both second nodes P and Q were detected to use 30% and 50% respectively of the 90.000 units, P and Q would now be allowed to apply [30/(30+50)]*62.000=23.250 units, and [50/(30+50)]*62.000=38750 units respectively.

The latter scenario seems in particular applicable in cases where a small number generate a large number of signaling and a relatively large number of other nodes generate a small number of signaling. In this case the signaling of the first node 100 for providing the signaling amount limitation tables is efficiently applied only to the nodes that may cause congestion.
A still further alternative is to discover which nodes show an upward trend in signaling and based on the expectation that this signaling will further increase in the next period, only these nodes are signaled with a signaling amount limitation table. E.g. from FIG. 5b, it is shown that node L has an increasing amount of signaling over the last four periods. This node L is than to be signaled with a signaling amount limitation table with a number of units equal to the last amount of signaling in column 550 or an average over the last few columns. This alternative for detecting a trend requires that first node 100 applies a storage unit for storing the determined accumulated processing load from step 411 for a number of periods A.
A still further alternative is to limit only the nodes which have no priority position in the network 1. Some second nodes are regarded to have a crucial function in the network, e.g. as an emergency system. In this case the signaling from this crucial second node should not be taken into consideration such that the signaling of all other second nodes is limited according to the method suggested.
A still further scenario is to limit the amount of processing by having at least one second node restricted in the type of submitting signaling, in that processing intensive signaling is reduced or queued by the second node.

FIG. 5c is a diagram illustrating a graph of an embodiment of method steps. FIG. 5c represents a time versus load graph 500 of the processing load in first node 100. At step 412 it is detected that the accumulated processing load is higher than the first threshold line Ts 530, caused by an unexpected increase in signaling by the second node(s), regarded as a potential danger to congestion of first node 100. The flow depicted in FIG. 2 shows that the signaling amount limitation table is immediately 412-414 send to the respective nodes, and the timers A and S are restarted 415.

In this case the period A is not completely performed by timer A, and the signaling amount limitation table, to be defined by first node 100, requires a normalized value the period of 30 s. So as an example if the processing load by second node K was detected to be 3.000 units on average over 4 seconds, and the defined corresponding signaling load should be 2.500 units, a normalization to 30 seconds would yield [(30/4)*2500=18.750 units for the next 30 seconds.

Optionally the non-normalized values of 4 s. and 2500 are provided to the second node K, as to let this second node decide how to handle the signaling.

Further optionally first node 100 deploys, for a limited number of next periods, a shorter period A, to reduce the chance that unexpected bursts in signaling are not in control by the first node 100, potentially causing congestion.

Thresholds line levels 520 and 530 can be adjusted by the network operator, however optionally in a self learning network the threshold levels are adapted by a management operation support system, in that a balance is to be found between the number of times a congestion is detected and the number of signaling by the first node 100 for submitting the signaling amount limitation to the second nodes.

When congestion in first node 100 is mainly caused by sudden bursts of signaling by the second nodes, either the period S should be shortened or the first threshold line Ts 530 lowered, or both. When congestion in first node 100 is mainly caused by the accumulated signaling load passing the second threshold line 520, either the period A should be shortened or the second threshold line 520 lowered, or both.

An alternative to the system of units of processing load, corresponding to an amount of signaling, as expressed in the signalling amount limitation table, submitted by the first node 100 to the second node, is a limitation expressed in number of messages, allowed to be submitted by the second node in a predetermined or specified period.

Additionally to the alternative the limitation is broken down into the types of messages to be submitted.

The determining step 411 of the accumulated processing load is suggested to be performed for all second nodes submitting signalling. In stable situations where a relatively small number of known nodes are known to consume almost the entire accumulated signalling load of first node 100, while other connected second nodes relatively hardly contribute to the accumulated processing load, it is an option to perform the determination step 411, for this small number of nodes only.

The method optionally proposes support for a further reduction in signalling in that the submission of the signalling amount limitation table to the respective second node is only performed if the table, compared to the previous one sent, has a limitation value that differs at least a minimum value. As an example, more than 5% more or less units, or corresponding signalling, would justify a submission of the signaling amount limitation table.

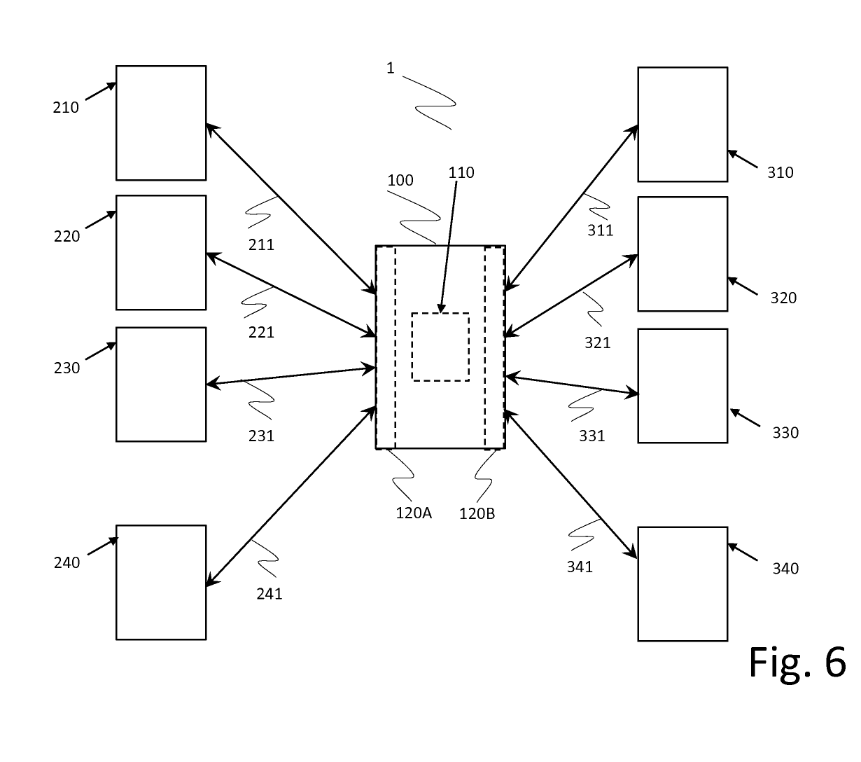

FIG. 6 is a block diagram illustrating an embodiment of a network.

Apart from the network nodes listed in FIG. 1, FIG. 6 comprises third network nodes 310, 320, 330, 340, each communicatively connected via bi-directional links 311, 321, 331, 341 respectively. FIG. 6 expresses a network embodiment where the first node 100 acts as an agent for third nodes 310, 320, 330 and 340. Four nodes shown as an example, although the invention is applicable to any number, being at least one, of third nodes

An agent in a network context is generally positioned between nodes that act as clients and servers. Agent can have a number of roles:
A relay agent uses the header information and routing related data of a message to choose the destination where to send the message to.
A proxy agent can modify data in a message and forward the message to a destination which might be determined from the content of the message. The data in the message might also act the proxy agent to apply a rule or as an example reject a request.
A Redirect agent returns requests to the originating client, providing information on the appropriate next hop that can service the request.
A translation agent translates messages from one into another protocol.

In a further example of the invention the first node 100 may act as an agent for a third node connected. First node 100 performs the steps for each third node separately, as each third node is a separate independent entity and as such may get congested if the second nodes, addressing a particular third node as a destination peer via first node 100, acting as e.g. a relay agent, submit more signalling than the particular third node is able to process.

For the remainder of the explanation third node 310 is applied as an example to be prevented for congestion by first node 100.

First node 100 performs step 411 by requesting third node 310 regularly for its current load, including the details of second nodes, responsible for the signaling causing the processing load in node 310, for a period A.

Several second nodes K, L, M, may have sent signalling towards node 310, resulting in a graph, comparable as depicted in FIG. 5a.

First node 100 subsequently checks 412 the first threshold line level 530 Ts, or checks 416 the timer A and processes the flow from FIG. 2 as described above. FIGS. 2, 4, 5a, 5b, and 5c and the accompanying explanations are m.m. applicable to this further example.

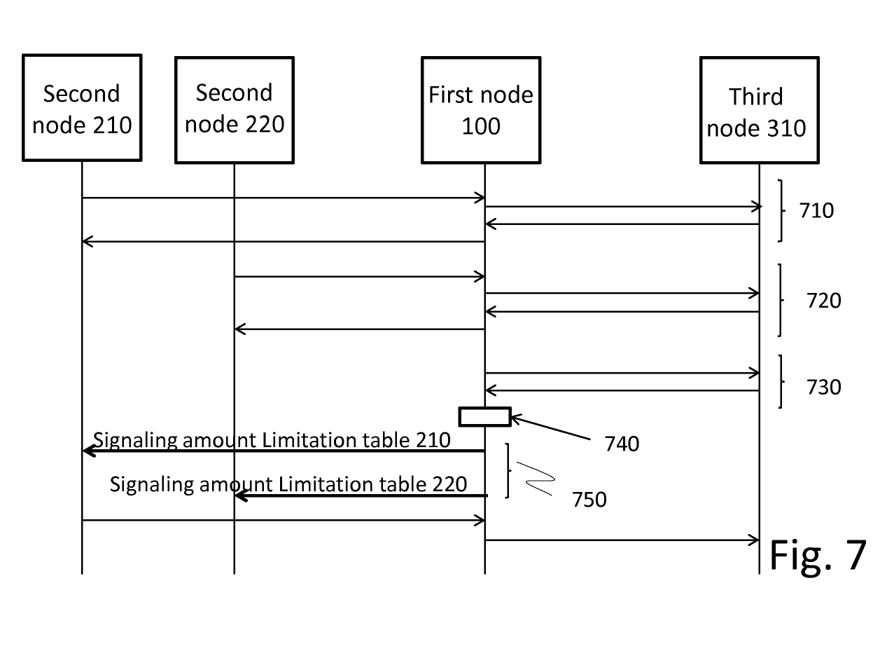

FIG. 7 is a signaling diagram illustrating an embodiment of method steps;

FIG. 7 presents, additional to the signaling diagram of FIG. 3, the third node 310 as an example.

Second nodes 210 an 220 are depicted as exchanging common signaling 710, 720 respectively with peer destination node 310, via first node 100, acting as a relay agent.

At some scheduled moment in time 730, first node 100 requests third node 730 for its current load, represented by step 411 in FIG. 2.

Subsequently first node 100, checks 740, whether a sudden increase in processing load is detected 412, or when a regular period A has ended 416.

When the checks 412 or 416 yield positive, a new signaling amount limitation for the particular second nodes is defined 413 in view of the particular third node 310 as destination node. Subsequently the signaling amount limitation tables are submitted 414, 750, and the timers reset 415. Next the second nodes continue normal signaling 630, albeit taking the last received signaling amount limitation taken into account when submitting signaling to third node 310, via first node 100 acting as an agent.

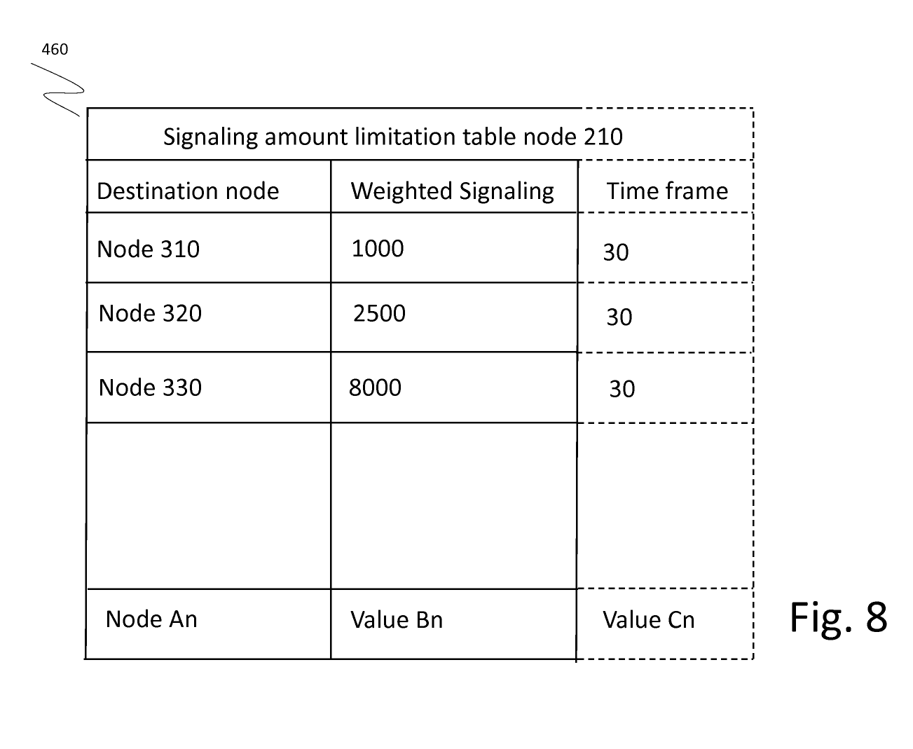

FIG. 8 is a diagram illustrating a table of an embodiment of method steps;

As being different from the example above, the second nodes in this further example may have more than one third node as destination peer, and it is regarded more efficient to combine the signalling amount limitation tables for the second nodes, such that all destinations peers are combined in one table. FIG. 8 combines the signalling addresses for each destination peer node 310, 320, 330, of a certain node, 210 in this example.

An alternative for requesting the third node for its load can be performed by first node 100, when it is defined that only the first node 100 acts as agent for the particular third node 310. In this particular case all signalling addressed for third node 310 is evaluated by first node 100 as it has to pass first node 100. This first node 100 applies a processing load corresponding table for the third node, like explained above, as to define the load resulting from the signalling received in the third node. In this way the load is the third node can already be estimated by the first node without requesting the third node for its actual load.

As a further example the first node 100, acting as an agent, as explained above for one or more third nodes, besides compiling a signalling amount limitation table for the third node, also defines a signaling amount limitation, derived from its own processing load as explained in FIGS. 1-5c above. The signaling amount limitation for first node 100, acting as an agent is either signaled to the respective second nodes as a single table, comparable as shown in FIG. 4, or added into a table comparable as shown in FIG. 8.

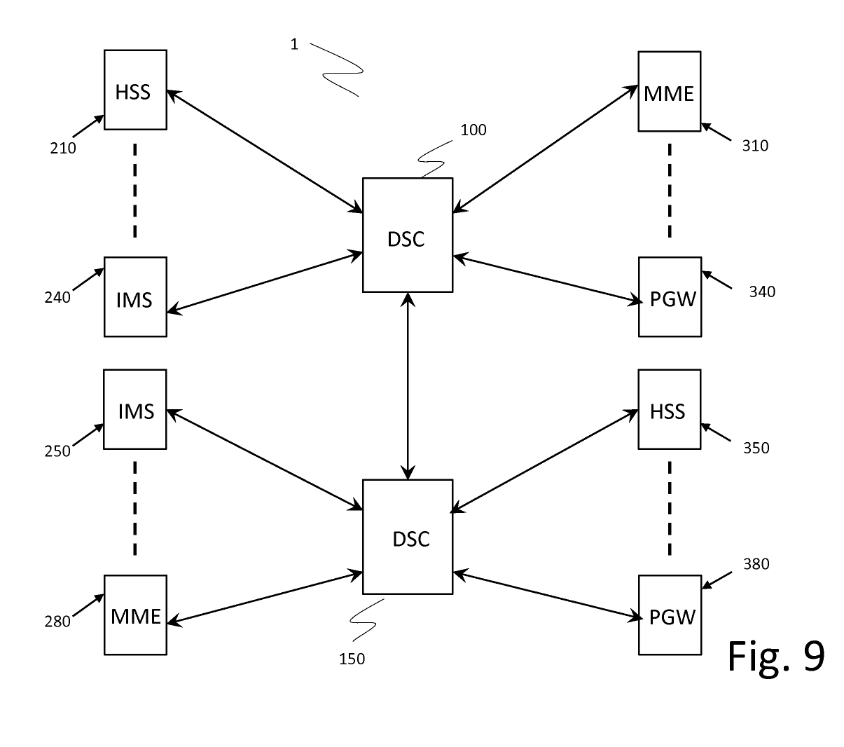

FIG. 9 is a block diagram illustrating an embodiment of a network;

Apart from the nodes shown in FIG. 6, the network 1 additionally shows a fourth node 150, a further second node 280 and a further third node 380. The arrows represent bi-directional links communicatively connecting the nodes. Although the examples above explain the method in submitting 210, 220, 230, 240, (client) and receiving 310, 320, 330, 340 (server) nodes, all second and third nodes are to be understood as being arranged to perform both roles simultaneously.

In Diameter signaling networks, applied in evolved mobile data networks, the Diameter protocol is applied to communicate between network nodes. The mobile network architectures, applying Diameter deploy a structure presented as in FIG. 9.

As an example of a Diameter based network the first node 100 and fourth node 150 connect remaining nodes 210, 240, 250, 280, 310, 340, 350, 380. The first node 100 and fourth node 150 are designated as Diameter Signaling Controlers (DSC) and the remaining mobile network nodes can be any of a non limited collection of a Home Subscriber Server (HSS), IP Multimedia Subsystem (IMS), Mobility Management Entity (MME), Policy and Charging Rules Function (PCRF) or Packet data network GateWay (PGW).

First node 100, and the fourth node 150, both have a number of nodes, only connected to either the first 100 or the fourth 150 node, thereby acting as agents between the connected remaining nodes.

The first node 100, and the fourth node 150 are suitable to apply the method presented above for these connected remaining nodes, and for the nodes 100, 150 themselves.

First node 100 and fourth node 150 are interconnected to allow signaling between domains controlled by either DSC. All nodes in this FIG. 9 are regarded to be Diameter nodes, arranged for submitting and receiving signaling according to the Diameter protocol.

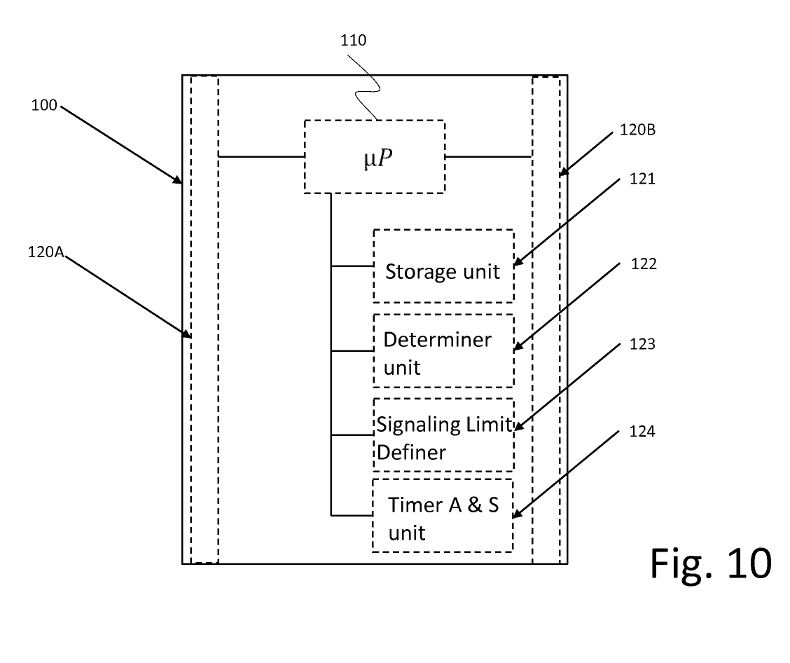

FIG. 10 is a block diagram illustrating an embodiment of a network node.

First node 100 and fourth node 150 are computer or cloud entities arranged to perform the steps of the method. Both nodes 100, 150 are explained in a single figure for first node 100, fourth node 150 node having identical features.

First node 100 has a processor 110 arranged to process program instructions and has additionally:
a memory 121 arranged to store the program instructions; an interface 120a, 120b for connecting to a plurality of second nodes;
a determiner unit 122 arranged to determine the processing load resulting from signaling received from the second node 210, 220, 230, 240, 250, 280;
a defining unit 123, arranged to define a signaling amount limitation for the second node.
a timer unit 124 for timing the period A and the scheduler timer S. the interface 120a, 120b is arranged to submit the defined signaling amount limitation to the respective second node.

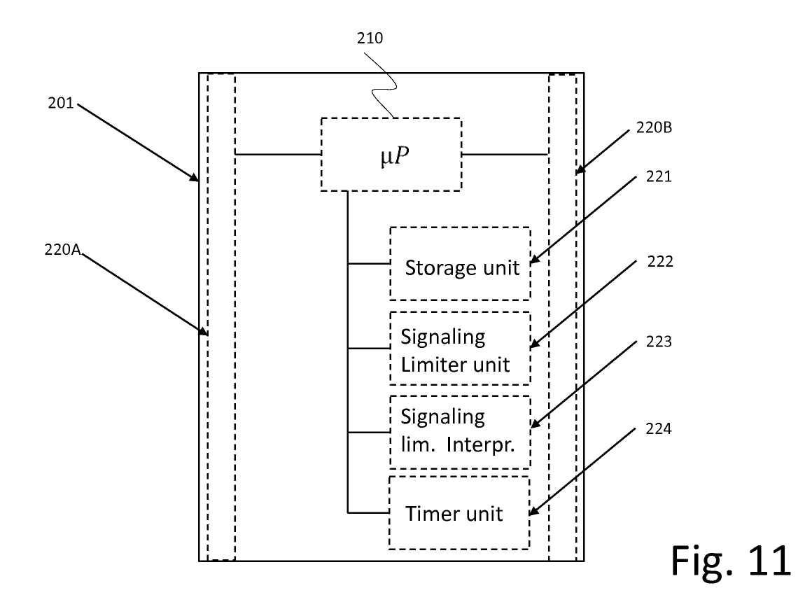

FIG. 11 is a block diagram illustrating an embodiment of a network node; Second node 210, 220, 220, 230, 240, 250, 280 are computer or cloud entities arranged to perform the steps of the method. All second nodes, arranged to submit signaling are explained in a single figure, all second nodes having identical features.

The second node has a processor 210 arranged to process program instructions and has additionally:
a memory 221 arranged to store the program instructions; an interface 220a, 220b for connecting to either the first 100 or fourth 150 node;
a signaling limiter unit 222 for limiting its submitting of signaling according the last received signaling amount limitation table;
a signaling conversion unit 223, arranged to convert the signaling amount limitation table in messages to be sent, and
a timer unit 224 for timing the period A in which an amount of signaling is allowed to be send according to the signaling amount limitation table.

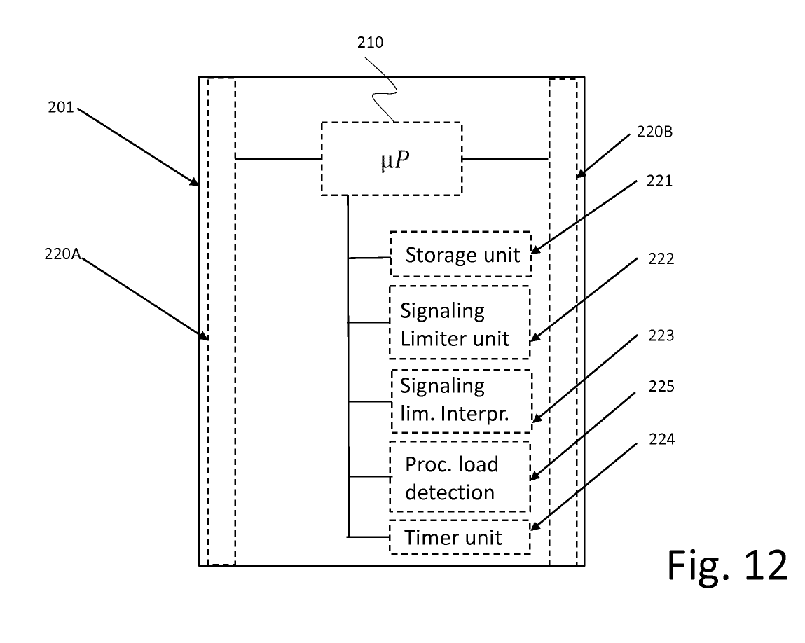

FIG. 12 is a block diagram illustrating an embodiment of a network node;

Additional to FIG. 11, FIG. 12 shows a processing load detection unit 225.

As stated above the second nodes 210, 220, 230, 240, 250, 280 and third nodes 310, 320, 330, 340, 350, 380 can be configures to perform both roles of submitting and receiving signaling as client-server partners simultaneously, FIG. 12 shows the required features for this performing both roles simultaneously.

The method as presented has the advantage that the control of the congestion in the first node 100 can be applied by the second node, responsible for submitting the signaling that might potentially cause the non-desired congestion. The control is applied close to the source, i.e. in the node potentially causing congestion.

The method aims at preventing congestion by reducing the signalling load in first node 100, but also has the advantage to reduce the network signalling load. A congested node might drop a signalling message or request, addressed for the node, possibly causing retransmissions of the same signaling message or request, increasing network bandwidth usage and requiring processing performance.

A congested or almost congested node might also sent signalling that it has to reject the request or message due to unavailable processing or other features. These replied rejections in a backward direction are signalling that has no result, also known as “blind load”. The rejections result into network load, but serve no effective purpose in that the original purpose of the signaling was not achieved and as such are still consuming network signalling bandwidth.

The method presented has the advantage is adaptive to the actual situation in that the processing load in the first node caused by the signaling of the second nodes is regularly determined, and regularly the signaling amount limitation tables are submitted according to the last determined second node signalling needs.

The method presented is applicable to networks of several topologies. Although explained for a star-like topology, the method is applicable to e.g. a mesh-like network.

In an aspect of the invention a method for controlling at least one second node is proposed. The method for controlling processing load in a first network node, wherein the processing load results from signaling received by the first node and the first node is communicatively connected to at least a second network node is performed by a number of steps described below.

A first determining step, by the first node is performed, wherein the processing load in the first node resulting from the signaling received from the at least one of a second node is determined.

A second defining step, by the first node is performed, wherein a signaling amount limitation for the at least one second node is derived from the determined processing load.

A third submitting step, by the first network node is performed, wherein the defined signaling amount limitation to the at least one second node is submitted, such that the at least one second node is enabled to limit its amount of signaling towards the first node, according to the defined signaling amount limitation.

In still another aspect of the invention, the determining step, determines for the at least one second node an amount of signaling received during a predetermined period. The determining step also includes accumulating of an amount of processing load in the first node resulting from the signaling received from the at least one second node over the predetermined period.

In still another aspect of the invention, the defining step comprises an allocation step, wherein, when the determined accumulated processing load is higher than a predetermined threshold level, the signaling amount limitation, that is at least a part of the accumulated processing load below the threshold level, is allocated to the at least one second node.

In still another aspect of the invention the submitting step of the method further comprises, the submitting of the defined signaling amount limitation as a table to the at least one second node, when the defined signaling amount limitation differs at least a predetermined value with the last submitted signaling amount limitation.

In still another aspect of the invention, there is presented a method for controlling a processing load in a third network node by a first network node. In this method the processing load results from an amount of signaling addressed to the third node and routed via the first node, the first node acting as an agent. The first node is communicatively connected to at least a second network node and the third node, the signaling is received from the at least one second node and the method comprises a number of steps stated below.

A first determining step is performed by the first node, determining the processing load in the third node resulting from the signaling received from the at least one second node via the first node.

A second defining step is performed by the first node, defining a signaling amount limitation for the at least one second node, derived from the determined processing load.

A third submitting step is performed by the first node, wherein the defined signaling amount limitation is submitted to the at least one second node, such that the at least one second node is enabled to limit its amount of signaling addressed to the third node, according to the defined signaling amount limitation.

In still another aspect of the invention, the determining step further comprises the determining for the at least one second node an amount of signaling received by the third node during a predetermined period. The determining step also includes accumulating of an amount of processing load in the third node, that results from the signaling received from the at least one second node over the predetermined period.

In still another aspect of the invention the defining step further comprises an allocation step when the determined accumulated processing load in the third node is higher than a predetermined threshold level. The signaling amount limitation, is at least a part of the accumulated processing load below the threshold level, and is allocated to the at least one second node.

In still another aspect of the method the submitting step further comprises the submitting of the defined signaling amount limitation as a table to the at least one second node when the defined signaling amount limitation differs at least a predetermined value with the last submitted signaling amount limitation.

In still another aspect of the invention, the first node acting as an agent for a third node is also enabled to have its own processing load controlled by having the determining step performed for both the third node and the first node, and perform the defining and submitting steps as presented above.

In still another aspect of the invention of controlling the processing load in a first or third network node, wherein the processing load results from the signaling load of a second node, a method is presented to enable the second node to control its signaling submission with steps illustrated below.

A first receiving step, performed by the second node, receives a signaling amount limitation table.

A second Interpreting step, performed by second node, interpreting a signaling amount limitation value of the table into a number and type of messages to be send within a predetermined period

A third limiting step, performed by the second node, limiting its amount of signaling sent towards the first or third node according to the interpreted signaling amount limitation.

In still another aspect of the invention a first network node is presented. The node arranged to control processing load in the first node, wherein the first node comprises: a processor arranged to process program instructions; a memory arranged to store the program instructions and an interface for connecting to at least a second node.

This first node additionally comprises; a determiner unit arranged to determine the processing load resulting from signaling received from the at least one second node and a definer unit, arranged to define a signaling amount limitation for the at least one respective second node.

The interface is arranged to submit the signaling amount limitation to the at least one second node, and the processor arranged to control the determiner unit, the definer unit and the interface

In still another aspect of the invention a second network node is presented, that is arranged to enable controlling a processing load in another network node.

The node comprises; a processor arranged to process program instructions; a memory arranged to store the program instructions, and an interface for connecting to a first node. The interface is arranged for submitting signaling and receiving a signaling amount limitation table.

The second node further comprises: a signaling interpreter unit for interpreting the signaling amount limitation value of the received table into a number and type of messages to be send within a predetermined period, and a signaling limiter unit for limiting the amount of signaling sent towards the first or third node according to the interpreted signaling amount limitation.

In still another aspect of the invention, a first network node is presented that has a congestion prevention module. This module comprises; a determination module for determining the accumulated processing load in the first or a third node, the load resulting from signaling received from at least one second node; a comparing module for comparing the accumulated processing load against a predetermined threshold, and a timer check module for checking whether a timer has timed-out.

The congestion prevention module further comprises; a definer module for defining a signaling amount limitation, based on the determined accumulated processing load and the predetermined threshold, and a submit module for submitting the signaling amount limitation as a table to the at least one second node as to enable the second node to limit its signaling according to the table.

In still another aspect of the invention, a computer program is presented, which, when being executed by a processor in a first network node, is adapted to carry out or control a method for preventing congestion in a first or third node comprising a number of steps.

In a first determining step, a processing load resulting from signaling received by the first node is determined.

In a second defining step, a signaling amount limitation for a second node derived from the determined processing load is detected.

In a third submitting step, the defined signaling amount limitation is submitted to the second node, such that the second node is enabled to limit its amount of signaling towards the first node, according to the defined signaling amount limitation,

In still another aspect of the invention, a computer program is presented, which, when being executed by a processor in a second node, is adapted to carry out or control a method for preventing congestion in a first or third node comprising a number of steps.

In a first receiving step, by the second node, a signaling amount limitation table is received.

In a second interpreting step, a signaling amount limitation value of the received table is interpreted into a number and type of messages to be send within a predetermined period.

In a third limiting step, by the second node, its amount of signaling towards a first node is limited according to the received defined signaling amount limitation.

1-22. (canceled)

23. A method for controlling processing load in a first network node, the processing load resulting from signaling received by the first node, the first node communicatively connected to at least a second network node, the method comprising the steps of:
determining, by the first node, the processing load in the first node resulting from the signaling received from the at least one of a second node;
defining, by the first node, a signaling amount limitation for the at least one second node, derived from the determined processing load; and
submitting, by the first network node, the defined signaling amount limitation to the at least one second node, such that the at least one second node is enabled to limit its amount of signaling towards the first node, according to the defined signaling amount limitation.

24. The method of claim 23, wherein the determining step further comprises:
determining for the at least one second node an amount of signaling received during a predetermined period.

25. The method of claim 24, wherein the determining step further comprises:
accumulating an amount of processing load in the first node resulting from the signaling received from the at least one second node over the predetermined period.

26. The method of claim 23, wherein the defining step further comprises:
allocating, when the determined accumulated processing load is higher than a predetermined threshold level, the signaling amount limitation, being at least a part of the accumulated processing load below the threshold level, to the at least one second node.

27. The method of claim 26, wherein the defining step further comprises:
the allocated signaling amount limitation expressed in processing load in the first node being equivalent to an amount of predetermined signaling for submitting by the second node.

28. The method of claim 23, wherein the submitting step further comprises:
submitting the defined signaling amount limitation as a table to the at least one second node, when the defined signaling amount limitation differs at least a predetermined value with the last submitted signaling amount limitation.

29. A method for controlling processing load in a third network node by a first network node, the processing load resulting from an amount of signaling addressed to the third node and routed via the first node, the first node communicatively connected to at least a second network node and the third node, the signaling received from the at least one second node, the method comprising the steps of:
determining, by the first node, the processing load in the third node resulting from the signaling received from the at least one second node via the first node;
defining, by the first node, a signaling amount limitation for the at least one second node, derived from the determined processing load; and
submitting, by the first node, the defined signaling amount limitation to the at least one second node, such that the at least one second node is enabled to limit its amount of signaling addressed to the third node, according to the defined signaling amount limitation.

30. The method of claim 29, wherein the determining step further comprises:
determining for the at least one second node an amount of signaling received by the third node during a predetermined period.

31. The method of claim 30, wherein the determining step further comprises:
accumulating an amount of processing load in the third node resulting from the signaling received from the at least one second node over the predetermined period.

32. The method of claim 29, wherein the defining step further comprises:
allocating, when the determined accumulated processing load in the third node is higher than a predetermined threshold level, the signaling amount limitation, being at least a part of the accumulated processing load below the threshold level, to the at least one second node.

33. The method of claim 32, wherein the defining step further comprises:
the allocated signaling amount limitation expressed in processing load in the third node being equivalent to an amount of predetermined signaling for submitting by the second node.

34. The method of claim 29, wherein the submitting step further comprises:
submitting the defined signaling amount limitation as a table to the at least one second node, when the defined signaling amount limitation differs at least a predetermined value with the last submitted signaling amount limitation.

35. The method of claim 29, wherein the determining step further comprises the step of:
determining, by the first node, the processing load in the first node resulting from the signaling received from the at least one second node.

36. The method of claim 35, wherein the determining step further comprises:
determining for the at least one second node an amount of signaling received by the third node during a predetermined period; and
accumulating an amount of processing load in the first node resulting from the signaling received from the at least one second node over the predetermined period.

37. The method of claim 35, wherein the defining step further comprises:
allocating, when the determined accumulated processing load in the first node is higher than a predetermined threshold level, the signaling amount limitation, being at least a part of the accumulated processing load below the threshold level, to the at least one second node, the allocated signaling amount limitation expressed in processing load in the first node being equivalent to an amount of predetermined signaling for submitting by the second node.

38. The method of claim 35, wherein the submitting step further comprises:
submitting the defined signaling amount limitation as a table to the at least one second node, when the defined signaling amount limitation differs at least a predetermined value with the last submitted signaling amount limitation.

39. A method for controlling processing load in a first network node or a third network node, the processing load resulting from signaling submitted by a second node to the first or third node, the method comprising the steps of:
receiving, by the second node, a signaling amount limitation table;
Interpreting, the signaling amount limitation value of the table into a number and type of messages to be send within a predetermined period; and
limiting, by the second node, its amount of signaling sent towards the first or third node according to the interpreted signaling amount limitation.

40. A first network node arranged to control processing load in the first node, the first node comprising:
a processor arranged to process program instructions;
a memory arranged to store the program instructions; and
an interface for connecting to at least a second node,
wherein the processor and memory are configured to:
determine the processing load resulting from signaling received from the at least one second node;
define a signaling amount limitation for the at least one respective second node, and
control the interface to submit the signaling amount limitation to the at least one second node.

41. A second network node arranged to enable controlling processing load in another network node, the second node comprising:
a processor arranged to process program instructions;
a memory arranged to store the program instructions;
an interface for connecting to a first node, the interface configured to signal and receive a signaling amount limitation table,
wherein the processor and memory are configured to:
interpret the signaling amount limitation value of the received table into a number and type of messages to be send within a predetermined period, and
limit the amount of signaling sent towards the first or third node according to the interpreted signaling amount limitation.

42. A non-transitory computer-readable medium comprising, stored thereupon, a computer program for execution by a processor in a first network node, wherein the computer program is configured so as to cause the first network node, when the processor is executing the computer program, to:
determine a processing load resulting from signaling received by the first node;
define a signaling amount limitation for a second node derived from the determined processing load; and
such the defined signaling amount limitation to the second node, such that the second node is enabled to limit its amount of signaling towards the first node, according to the defined signaling amount limitation.

43. A non-transitory computer-readable medium comprising, stored thereupon, a computer program for execution by a processor in a second node, wherein the computer program is configured so as to cause the second network node, when the processor is executing the computer program, to:
receive a signaling amount limitation table;
interpret a signaling amount limitation value of the received table into a number and type of messages to be send within a predetermined period; and
limit the second node's amount of signaling towards a first node according to the received defined signaling amount limitation.
